(19) United States
(12) Patent Application Publication
(10) Pub. No.: US 2009/0009987 A1
(43) Pub. Date: Jan. 8, 2009

(54) Flashlight retention device and method of using the same

(76) Inventor: Matthew V. Graham, Culpepper, VA (US)

Correspondence Address: R. Tracy Crump, P.O. Box 604, New Carlisle, IN, 46552-0604, US

(21) Appl. No.: 12/151,966

(22) Filed: May 9, 2008

Related U.S. Application Data
(60) Provisional application No. 60/928,809, filed on May 11, 2007.

(51) Int. Cl. F21L 4/04; F41G 3/26

(52) U.S. Cl. 362/110; 362/206; 42/146; 434/21

(57) ABSTRACT

The retention device fits to a conventional hand-held flashlight with a tail-end switch and allows a shooter to manipulate both the flashlight and a firearm while not violating any fundamentals of marksmanship, namely the two handed grip on the firearm. The retention device is made of a resilient and pliable rubber or elastomeric material and includes an annular connection band, which slides over the cylindrical body of the flashlight. The connection band is positioned near the tail-end of the flashlight opposite the bezel. The band has a chamfered edge, which is used as a contact surface for the shooter's fingers. The retention device may also include an integral finger loop or finger hook, which provides positive retention of the flashlight with the shooter's hand. Both the integral finger loop and finger hook extend from the flat back of the band extending forward over the band toward the bezel end of the flashlight. The retention device and its method of use allows the shooter to maintain proper fundamentals of marksmanship, namely a two handed combat grip of the firearm, while still operating the flashlight. The retention devices of this invention also allow the shooter to execute weapon reloads, malfunctions and clearance/stoppage operations while maintaining positive retention of the flashlight and proper firearms technique.

This invention relates to a retention device for small handheld flashlights and a method for using the same with a firearm.

### BACKGROUND OF THE INVENTION

The effective use of a firearm is based on the fundamentals of marksmanship, which include: stance, grip, sight alignment, sight picture, trigger control, breath control, and follow through. At night or in low light condition, the effective use of firearms is greatly complicated. A low light firearms engagement often requires the use of a handheld flashlight. While the fundamentals of marksmanship are just as applicable in low light firearms engagements, the use of hand-held flashlights violates one of the key fundamentals. Because one hand must hold the flashlight, the fundamental two hand “combat” grip on the firearm is compromised in a low light engagement. When accuracy and consistency is most vital, in a fire fight in the dark, the accuracy and consistency provided by the two handed grip on the firearm is compromised in order that one hand be free to employ the flashlight. A variety of techniques have been developed for simultaneously employing a flashlight and a firearm in a low-light engagement. These one-hand techniques include the Harris Method, the Chapman Method, the FBI method and the Rogers/SureFire Method.

None of these techniques adequately address the compromise of the fundamentals of a firearm marksmanship while using a handheld flashlight. Typically, the support hand holds and operates the flashlight while supporting or bracing the strong hand, which holds and operates the firearm. Again, the fundamental two-handed grip on the weapon is compromised in all of these “one-handed” techniques. Although a fundamental of marksmanship is lost, the conventional wisdom is that accuracy and consistency can be maintained using these “one-handed” techniques with just a healthy amount of “hard focus on the front sight”. The human mind can only focus effectively on one task at a time. Unfortunately, shooters often are caught in a vicious feedback loop of trying to center their light source on the target then readjust their aim, and re-center their light source, and on and on. These “light in one hand, gun in the other, and try to make it work” techniques are woefully inadequate for life and death engagements. No low light technique should violate a key fundamental of marksmanship.

For example, the Harris method was invented by Michael Harris and is considered one of the first techniques that coordinates the use of the flashlight using two hands. Used with a hand-held tactical flashlight with a tail-end activation switch (a longitudinal push button on the end cap of the light), the flashlight is grasped with the left hand around the body and the thumb will activate the switch. The back of the hands are pressed together and maintain an isometric tension to help control the recoil of the gun. The shooter's wrists will be crossed and the light will be parallel or close to the muzzle of the gun. Using the Harris Method, the shooter never attains a proper two handed grip on the firearm.

A variety of flashlight accessories have been developed to lessen some of the deficiencies in these “one-handed” techniques and to help more effectively use a conventional handheld flashlight and a firearm simultaneously in a low light engagement. The most common is a simple rubber ring placed around the bodies of the flashlight with a tail-end activation switch, which allows the shooter to hold the light between his fingers and pull the light back against the inside of his palm to activate the light. This device led to the innovation of the “Rogers/SureFire Method.” The Roger/Surefire Method was developed by Bill Rogers who adapted a rubber grommet or washer to a Surefire® 6Z flashlight. The position is also called the cigar position, as you grasp the body of the flashlight like a cigar, with the index and middle finger. The tail cap is resting on the fleshy part below your thumb and a little pressure back on the rubber ring will activate the light (the tail cap button resting in that part below your thumb will switch the light on). That position will let a shooter grasp the hand shooting the pistol with three fingers of the left hand. Although the Roger-SureFire method allows a shooter to use a two-handed grip, this two-handed grip does not properly position the hands and deviates significantly from the principles of marksmanship.

A variety of specialized flashlights have also been developed, which conform to a shooter's hand and allow him to employ a firearm as well as operate the light. An example of one of these specialized lights is found in U.S. Pat. No. 6,641,277. While partially addressing the deficiencies in marksmanship fundamentals, these specialized flashlights are oddly shaped and not convenient to carry or use in tactical or every day applications.

Because the standard hand-held flashlight with a tail-end switch remains the most practical and carriable flashlight in most applications and environments, the manipulation of both a standard hand-held flashlight and firearm without deviating from the fundamentals of marksmanship remains a problem.

### SUMMARY OF THE INVENTION

The present invention provides a retention device fitted to a conventional hand-held flashlight with a tail-end switch, which allows a shooter to manipulate both the flashlight and a firearm while not violating any fundamentals of marksmanship, in particular, the two handed grip on the firearm. Each embodiment of the retention device of this invention is made of a resilient and pliable rubber or elastomeric material and includes an annular connection band, which slides over the cylindrical body of the flashlight. The connection band is positioned near the tail-end of the flashlight opposite the bezel. The band has a chamfered edge, which is used as a contact surface for the shooter's fingers. Two embodiments of the retention device of this invention also include an integral finger loop or finger hook, which provides positive retention of the flashlight with the shooter's hand. Both the integral finger loop and finger hook extend from the flat back of the band extending forward over the band toward the bezel end of the flashlight.

The present invention also provides a method of using the retention device on the flashlight in conjunction with the operation of a firearm. The use of the retention device of this invention allows the shooter to execute a five stage presentation of a firearm (grip, draw, cant, marry and push to extension) while positively supporting and retaining the flashlight between adjacent fingers and also activating the flashlight by simply pulling the flashlight with the shooter's non-weapon hand against the back of the shooter's fingers on his weapon hand. The retention device allows the shooter to maintain proper fundamentals of marksmanship, namely a two handed combat grip of the firearm, while still operating the flashlight. The retention device also allows the shooter to execute weapon reloads, malfunctions and clearance/stoppage operations while maintaining positive retention of the flashlight and proper firearms technique.

These and other advantages of the present invention will become apparent from the following description of an embodiment of the invention with reference to the accompanying drawings.

### BRIEF DESCRIPTION OF THE DRAWINGS

The drawings illustrate an embodiment of the present invention, in which:

FIG. 1 is a perspective view of a first flashlight retention device embodying this invention;

FIG. 2 is a side view of the flashlight retention device of FIG. 1;

FIG. 3 is a front view of the flashlight retention device of FIG. 1;

FIG. 4 is a back view of the flashlight retention device of FIG. 1;

FIG. 5 is a top view of the flashlight retention device of FIG. 1;

FIG. 6 is a bottom view of the flashlight retention device of FIG. 1;

FIG. 7 is a perspective view of a second flashlight retention device embodying this invention;

FIG. 8 is a front view of the flashlight retention device of FIG. 7;

FIG. 9 is a back view of the flashlight retention device of FIG. 7;

FIG. 10 is a right side view of the flashlight retention device of FIG. 7;

FIG. 11 is a left side view of the flashlight retention device of FIG. 7;

FIG. 12 is a top view of the flashlight retention device of FIG. 7;

FIG. 13 is a bottom view of the flashlight retention device of FIG. 7;

FIG. 14 is a perspective view of a third flashlight retention device embodying this invention;

FIG. 15 is a front view of the flashlight retention device of FIG. 14;

FIG. 16 is a back view of the flashlight retention device of FIG. 14;

FIG. 17 is a top view of the flashlight retention device of FIG. 14;

FIG. 18 is a right side view of a user's hands using a firearm and the flashlight retention device of FIG. 1 in a direct illumination position;

FIG. 19 is a left side view of a user's hands using a firearm and the flashlight retention device of FIG. 1 in a direct illumination position;

FIG. 20 illustrates a shooter's initial grasps of a holstered flashlight using the retention device of FIG. 1;

FIG. 21 illustrates the shooter lifting the flashlight clear from its holster;

FIG. 22 illustrates the shooter's initial posture before presenting the firearm and flashlight;

FIG. 23 illustrates the shooter having drawn the firearm and flashlight using the retention device of FIG. 1;

FIGS. 24 and 25 illustrate a shooter marrying his hands together in a traditional two handed “combat” grip on a firearm with the flashlight in the direct illumination position;

FIG. 26 is a front view illustrating the shooter fully presenting the firearm with the flashlight in the direct illumination position;

FIG. 27 is a right side view of a user's hands using a firearm and the flashlight retention device of FIG. 1 in an offset illumination position;

FIG. 28 is a left side view of a user's hands using a firearm and the flashlight retention device of FIG. 1 in an offset illumination position;

FIG. 29 illustrates a shooter's initially grasp of a holstered flashlight using the retention device of FIG. 1 for use in an offset illumination position;

FIGS. 30 and 31 illustrate the operator manipulating the flashlight with the retention device of FIG. 1 into a “tactical working” position;

FIG. 32 illustrates an operator holding and indexing a firearm magazine along with the flashlight and retention device of FIG. 1;

FIGS. 33 and 34 illustrate the operator inserting a magazine into the firearm and working the slide of the firearm while holding the flashlight and retention device of FIG. 1; and

FIGS. 35 and 36 illustrate the operator inserting a magazine into the firearm and working the slide of the firearm while holding the flashlight and retention device of FIG. 1 in an alternative retention technique.

### DESCRIPTION OF THE PREFERRED EMBODIMENT

In addition to providing a written description of the different embodiments of the retention device of this invention, this description of the preferred embodiments and accompanying drawings illustrate a method of employing a flashlight and retention device in conjunction with the tactical operation of a firearm, such as a pistol. The retention devices of this invention can be used with any handheld flashlight having a push button tail-end switch, such as the flashlights manufactured by SureFire, LLC. of Fountain Valley Calif. This invention provides for a flashlight 2 having a tubular battery barrel or body 4, a push button tail-end activation switch 6 for the flashlight, and a lamp assembly 8. Ideally, battery barrel 4 has an outer diameter that allows for the barrel to be held between adjacent fingers of the human hand.

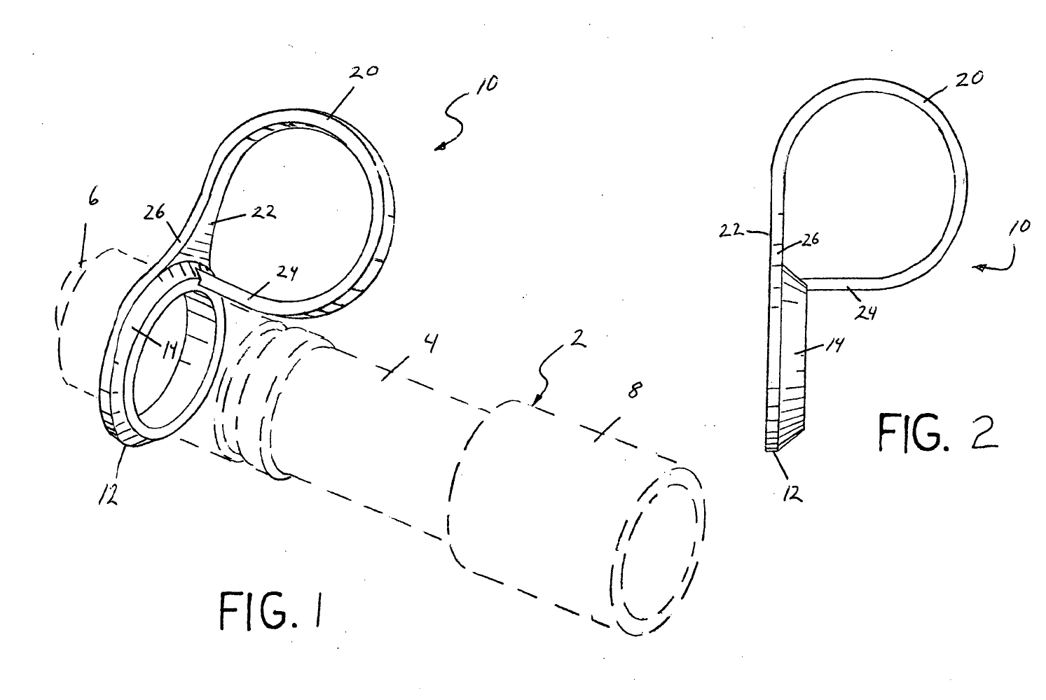

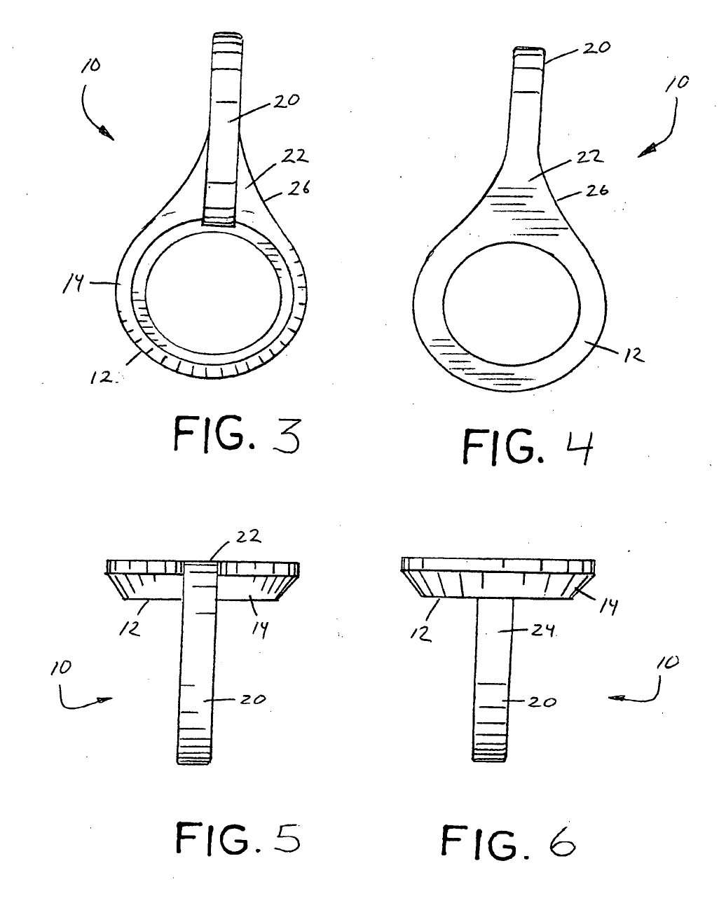

FIGS. 1-6 illustrate one embodiment of the retention device of this invention, which is designated generally as reference numeral 10. Retention device 10 is made of a resilient and pliable rubber or elastomeric material. The elastomeric material for retention device 10 is selected to allow the device to be friction fit to the cylindrical bodies of a flashlight; however, the material should also allow the device to slide over, rotate on and twist about a human finger while manipulating the device and flashlight. As such, a combination of different materials may be combined or integrated in the construction of retention device 10.

As shown, retention device 10 includes an annular connection band 12, which slides over the cylindrical battery barrel 4 and an integral finger ring or loop 20 for receiving a finger of the shooter's hand. As shown, band 12 is positioned at the distal end of flashlight 2 adjacent the tail-end switch 6. The inner diameter of band 12 is dimensioned to accommodate a flashlight body with outer diameters between 0.75 and 1.25″ The elastic properties of the material from which each retention device is constructed allows band 12 to slide over and hold its position along battery barrel 4. While the elastic properties of the retention device material are sufficient to hold the band to the battery body, band 12 ideally sits within an annular groove 5 formed in battery barrel 4, which provides a more positive engagement between the ring and flashlight body. Even seated within groove 5, band 12 extends radially from battery barrel 4 approximately ⅜-⅝ of an inch. Band 12 has a chamfered leading edge 14, which faces lamp assembly 8 of flashlight 2. It should be noted that band 12 extends radially from battery barrel 4 of flashlight 2 so that chamfered edge 14 provides a contact surface against which a user can apply force with his fingers when positioned between adjacent fingers of the user's hand.

Finger loop 20 has an inner diameter dimensioned to allow a user's finger to extend through the loop. This inner diameter ranges between 0.75 and 1.50 inches. While band 12 lies in a plane perpendicular to the longitudinal axis of flashlight 2, finger loop 20 lies in a plane, which is perpendicular to the plane of band 12. As shown, finger loop 20 extends from the flat back of band 12 extending forward over the band toward the bezel end of flashlight 2. As shown, finger loop 20 has a substantial flat back portion 22 with tapered edges that neck down to a consist diameter as the loop curves back around to a flat return portion 24 that converges back into chamfered edge 14 of band 12. Flat back portion 22 of finger loop 20 also has tapered edges 26 to provide a larger contact area for the shooter's fingers to engage retention device 10. It is also preferable that the material used along flat back portion 22 of the finger loop 20 be slightly thicker to provide more rigidity than the remaining portion of the finger loop. It should be noted that the junction where the integral finger loop 20 meets chamfered edge 14 of band 12 is scored to provide a “break free” point. This “break free” point allows the ends of the loop to sever and separate to free a user's finger, if an assailant grabs the flashlight.

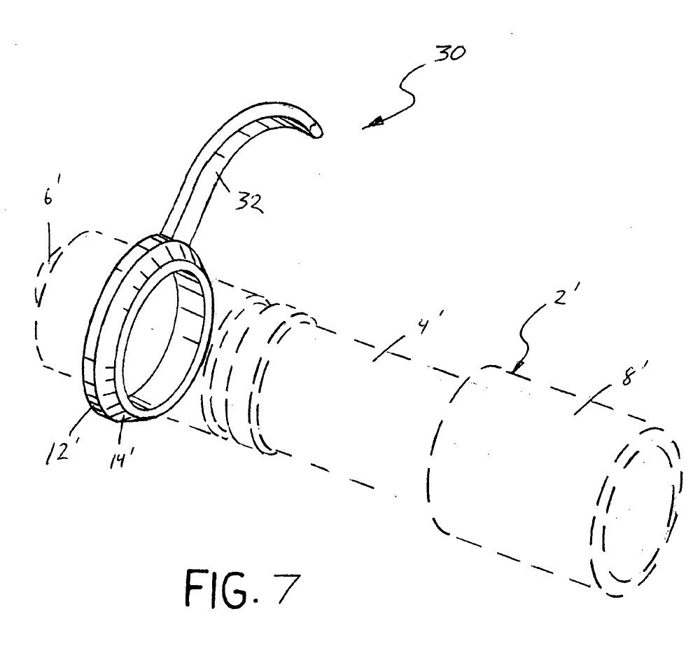

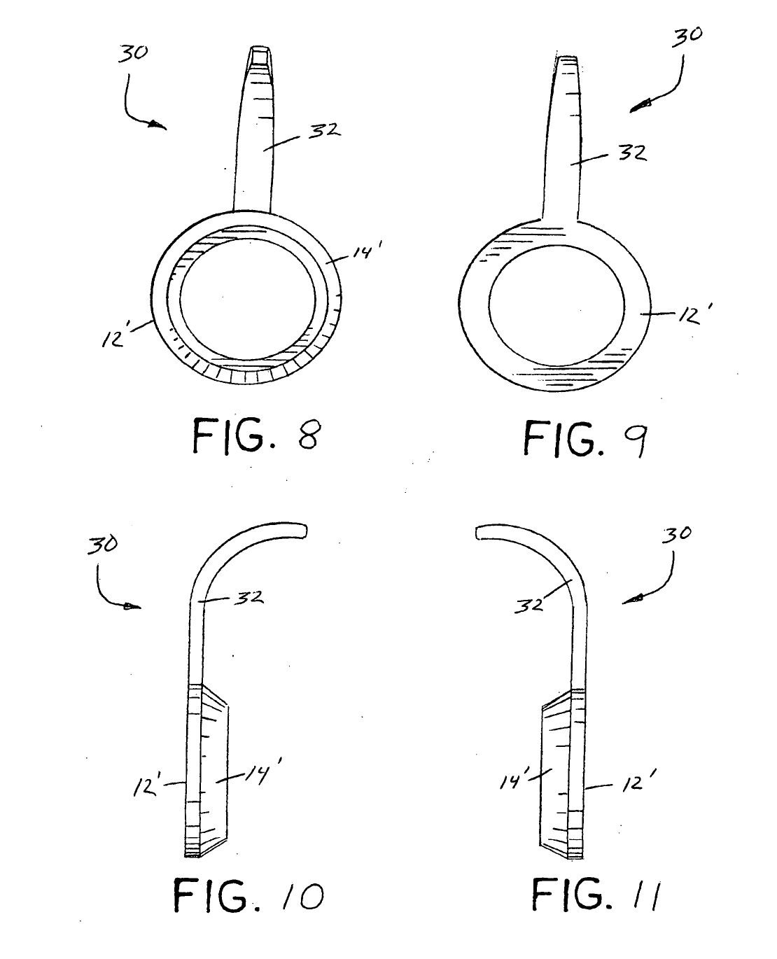

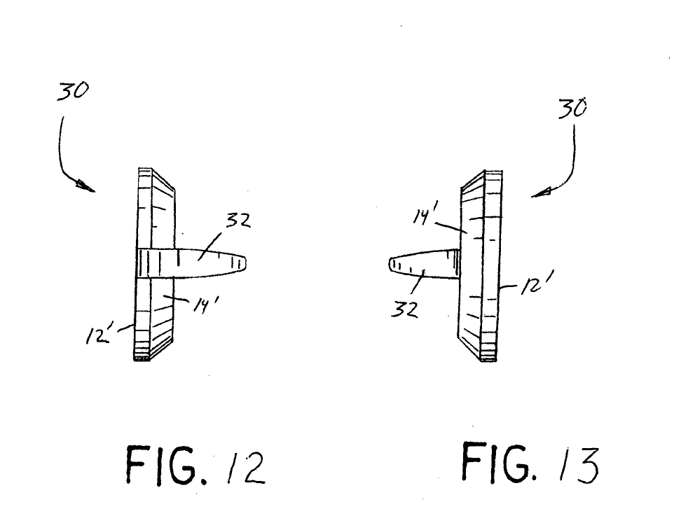

FIGS. 7-13 illustrate a second embodiment of the retention device of this invention, which is designated generally as reference numeral 30. Retention device 30 is similar in design and construction as device 10, and includes an identical connection band 12′. Device 30 differs from device 10 in that finger loop 20 of device 10 is replaced with a curved finger hook 32. Like the finger loop 20 of retention device 10, finger hook 32 extends from the flat back of band 12′ extending forward over the band toward lamp assembly 8 of flashlight 2 terminating in a curved end 34 spaced over the battery barrel 4 of flashlight 2.

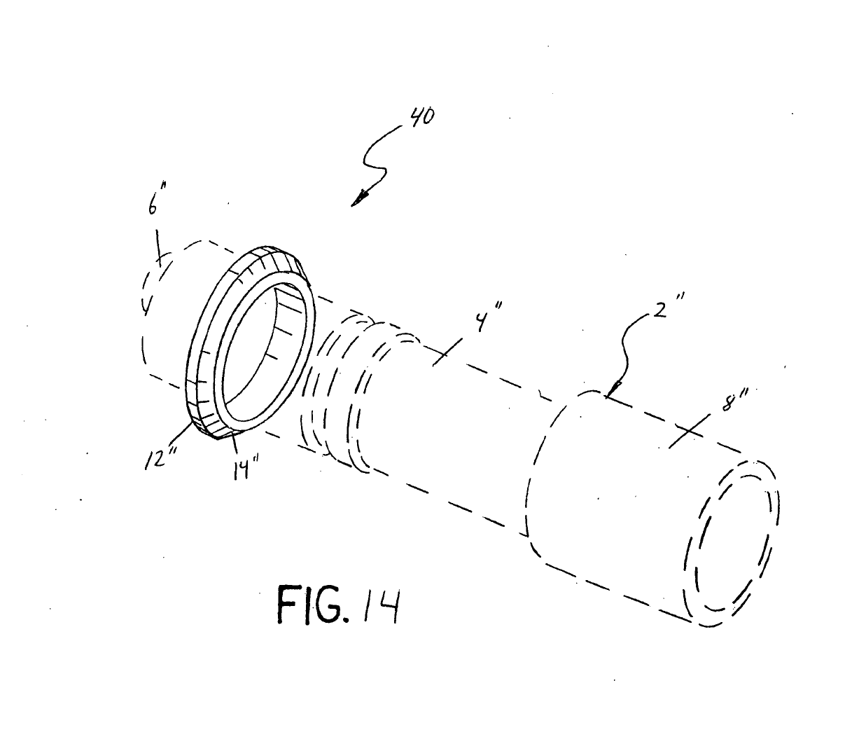

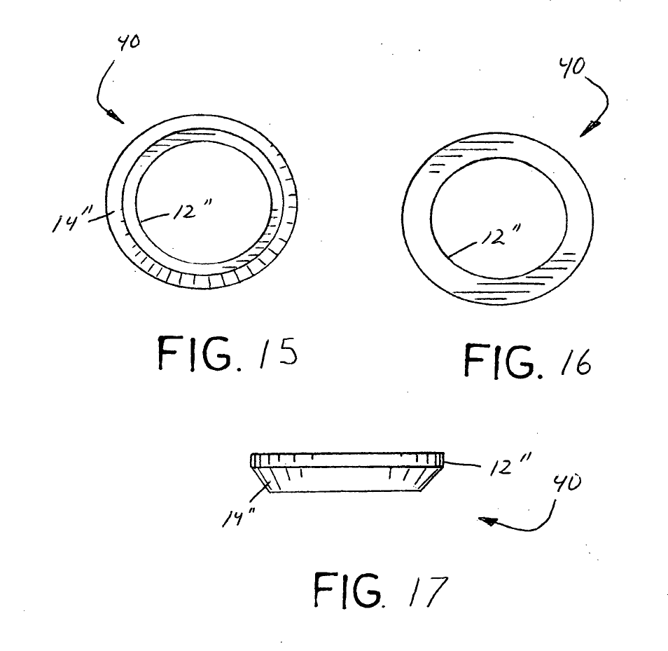

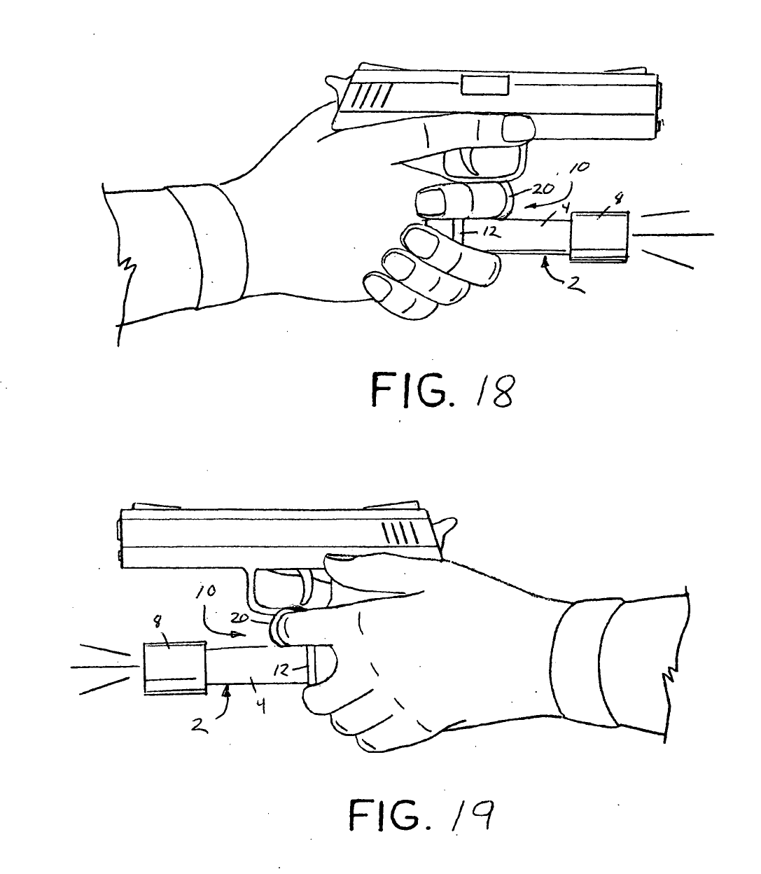

FIGS. 14-17 illustrate a third embodiment of the retention device of this invention, which is designated generally as reference numeral 40. Retention device 40 is similar in design and construction to both retention devices 10 and 30, but constitutes only the connection band 12″ and eliminates the finger loop and hook of the other retention devices. While retention device 40 still provides enhanced retention ability, it lacks the additional positive retention provided by the finger loop and hook of retention devices 10 and 30.

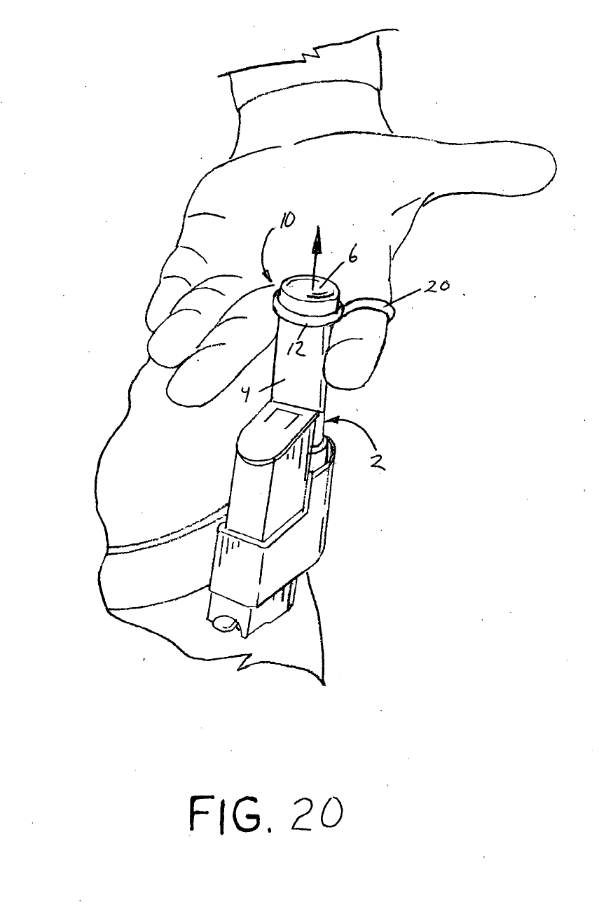

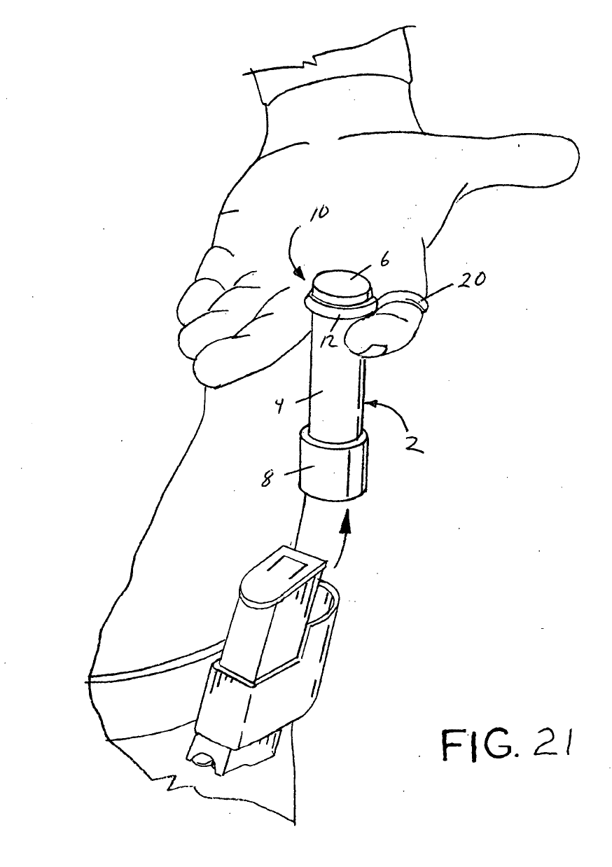

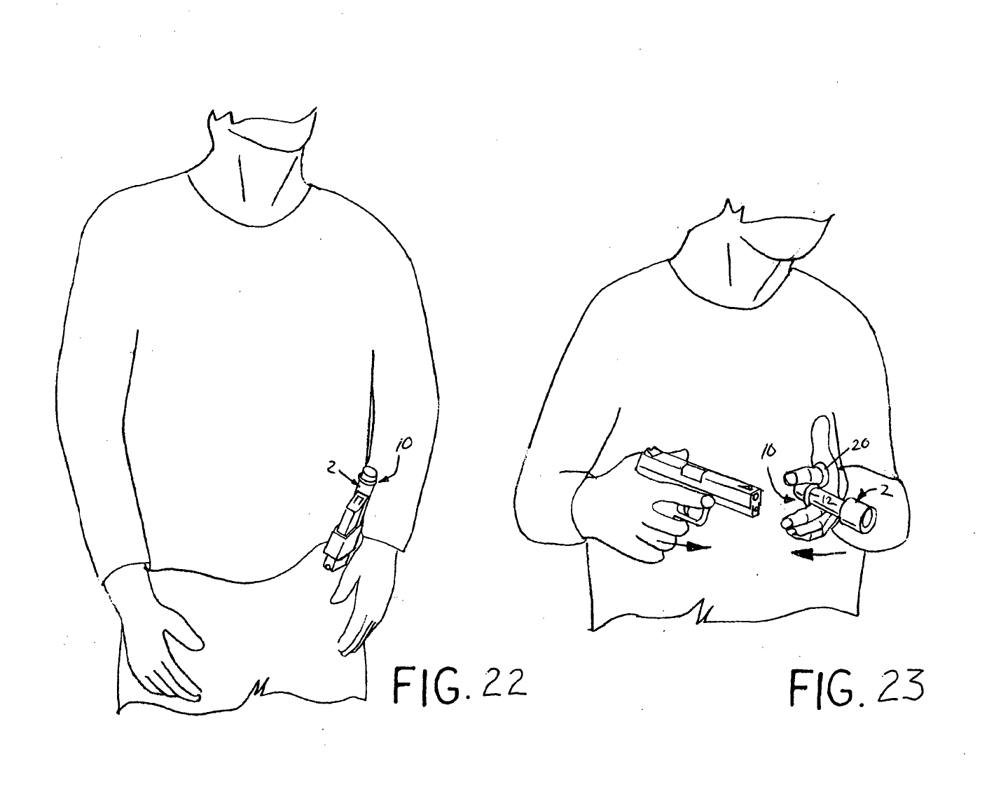

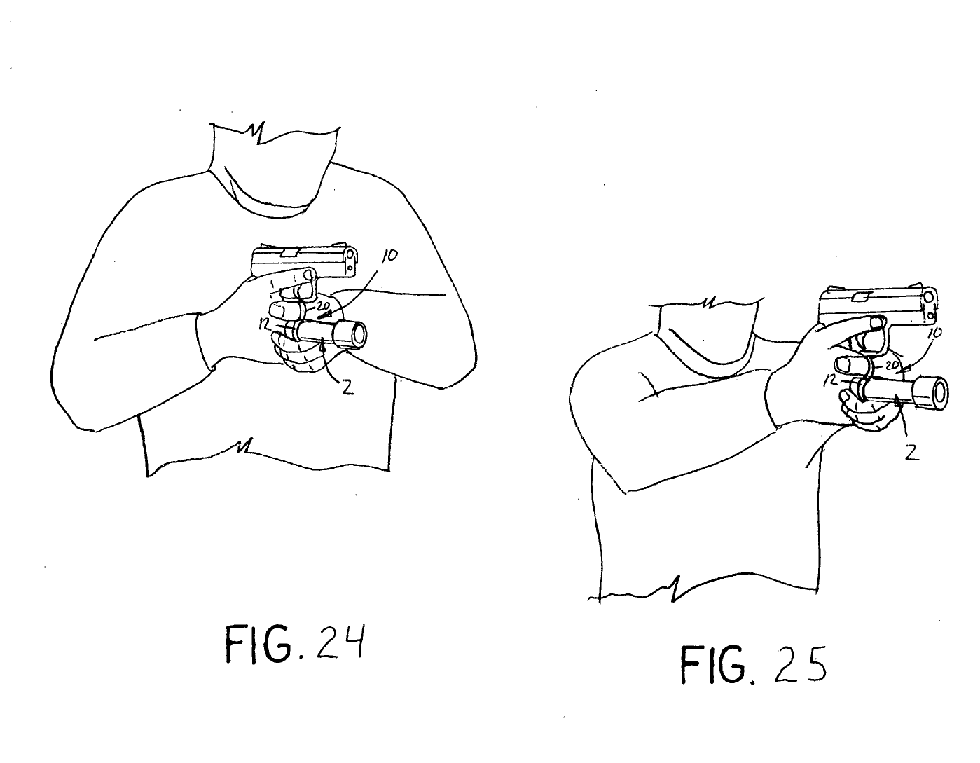

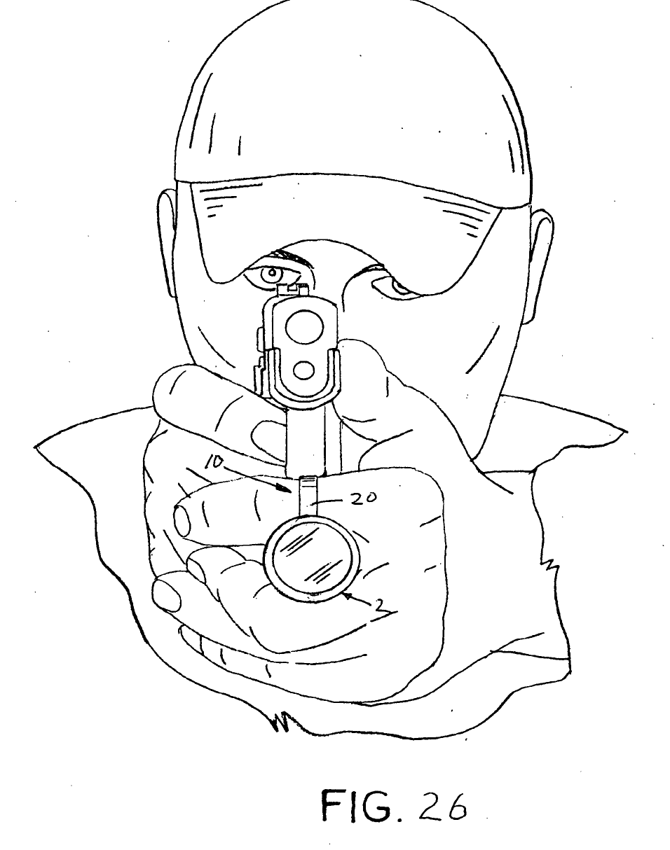

FIGS. 18-26 illustrate the method of using the retention devices of this invention through a standard five stage presentation of a firearm. The five stage presentation of a firearm is a well know technique that is commonly understood by firearms instructors and shooters, which includes five distinct movements: grip (FIG. 20), draw (FIGS. 21 and 22), cant (FIG. 23), marry (FIG. 24) and push to extension (FIG. 25). However, the method of this invention focuses on the use of the retention device with a flashlight in conjunction with the presentation of the firearm, regardless of the specific technique used to present or aim the firearm. For simplicity of explanation, the method of use is illustrated with retention device 10, although the method of use for retention devices 30 and 40 are similar and only differ in the orientation and convenience provided by the finger loop and hook. Such differences being readily apparent without additional explanation.

As shown, the method begins with flashlight 2 holstered bezel down on the shooter's non-firing side (the left side as shown). With the flashlight holstered bezel down exposing retention device 10 and tail-end switch 6, the shooter's non-firing hand has immediate access to retention device 10 and finger loop 20 in particular. The shooter orients his hand palm up and inserts his index finger of his weak hand through finger loop 20 registering flashlight 2 between his index and middle fingers in the area of the center knuckle with the tail-end switch raised slightly above the palm (FIG. 20). As the shooter begins his five stage presentation of the firearm, the shooter places his weapon hand (the right hand as shown) on the weapon and draws the firearm from its holster while simultaneously drawing flashlight 2 from its holster (FIG. 21). As the shooter marries his hands together as he would in his standard two handed firing grip, flashlight 2 extends parallel with the barrel of the firearm with tail-end switch 6 being sandwiched between the users two hands (FIGS. 18, 19 & 23). The actual hand position will vary from shooter to shooter dependent on the size of the shooter's hand and the shooter's own comfort zone. Flashlight 2 is kept in position by the shooter's grasp of retention device 10 and flashlight 2 between the fingers and pressure of the shooter urging the retention device and flashlight against the back of the fingers of the shooter's weapon hand. To activate flashlight 2, the shooter increases the pressure of his non-weapon hand on retention device 10 and flashlight 2 against his weapon hand to depress tail-end switch 6. The pressure activates the tail-end switch 6 and flashlight 2 illuminates. Decreasing the pressure deactivates flashlight 2. It should be noted that chamfered edge 14 of band 12 extends radially from battery barrel 4 of flashlight 2 to provide sufficient contact with shooter's fingers to facilitate urging the flashlight against the shooter's weapon hand. As best shown in FIGS. 18, 19 and 26, holding flashlight 2 between the index and middle fingers using retention device 10 positions the flashlight for direct illumination of the weapon's aim point. Registering flashlight 2 between the index and middle fingers positions the flashlight generally parallel with the barrel of the firearm to illuminate the weapon's point of aim.

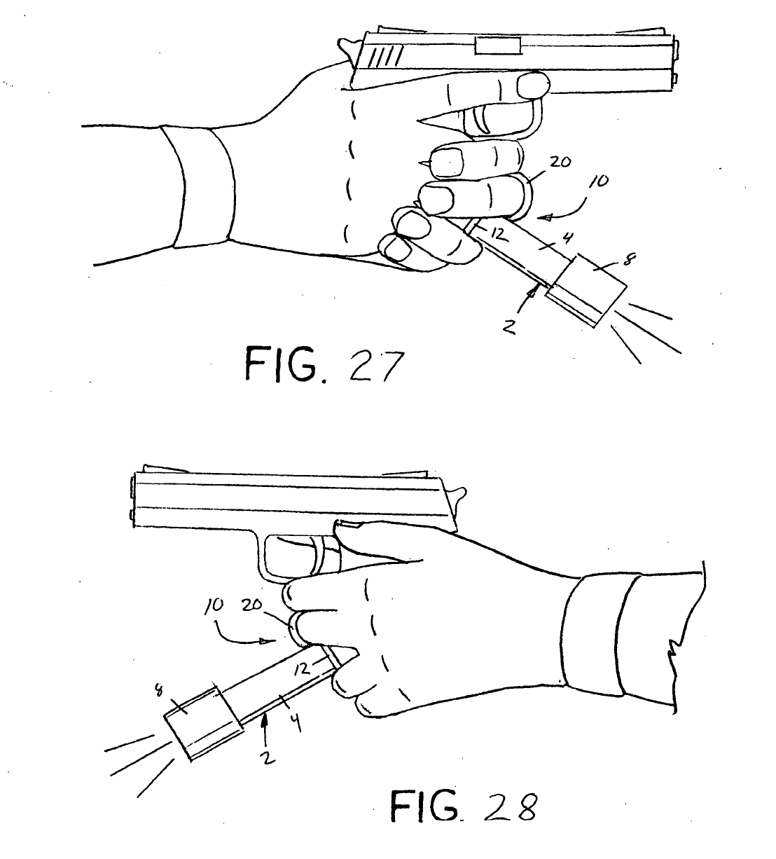

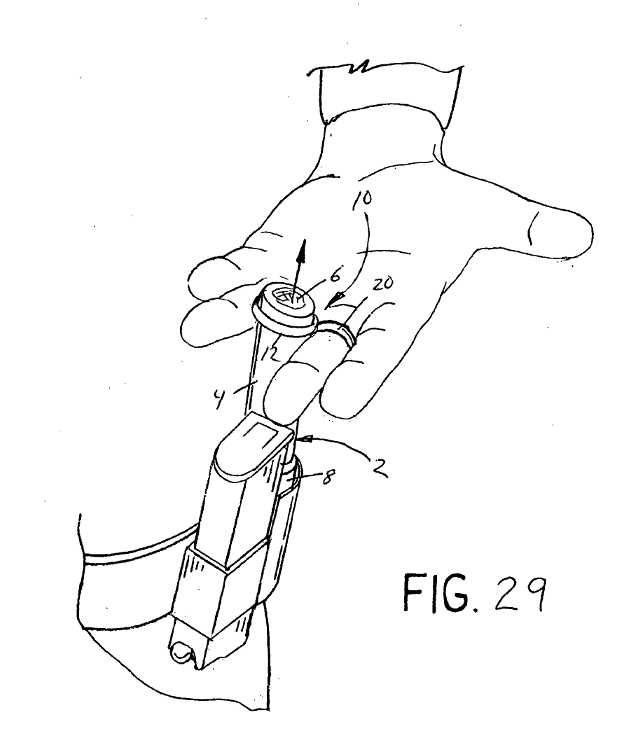

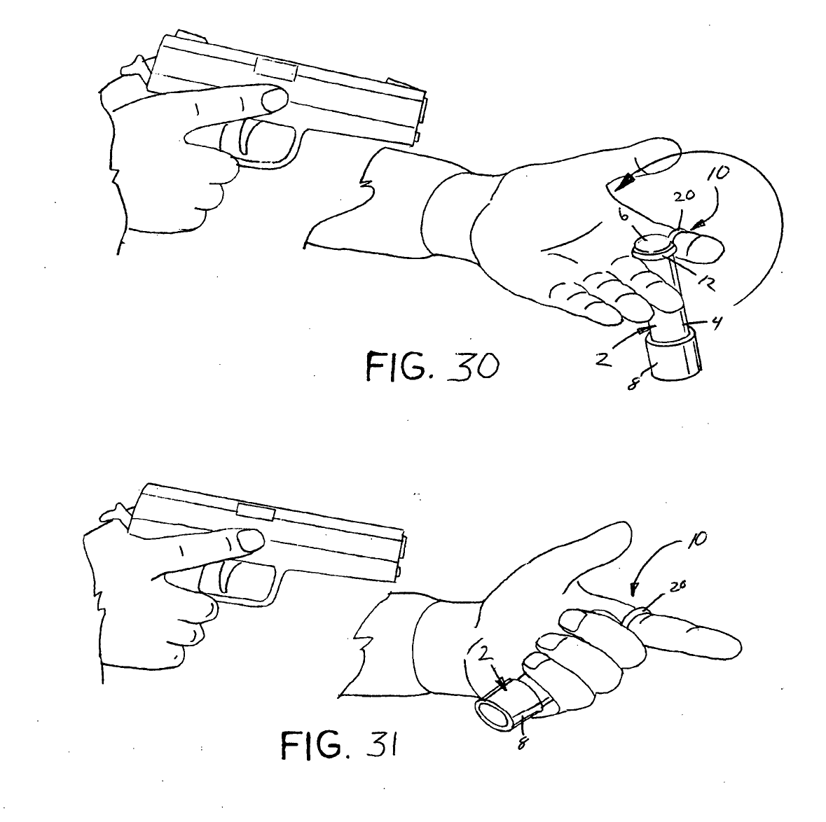

FIGS. 27-29 illustrate a slight variant of the method of use where flashlight 2 is registered between the middle and ring fingers for ambient illumination, instead of the middle and index fingers as for direct illumination. In this position, flashlight 2 and the light beam therefrom is angled downward slightly (approximately 10-35°) to provide ambient illumination instead of direct illumination. As shown in FIG. 29, the shooter's initial grasp and draw of flashlight 2 using retention device 10 is identical to that described above, except that the flashlight is registered between the middle and ring fingers.

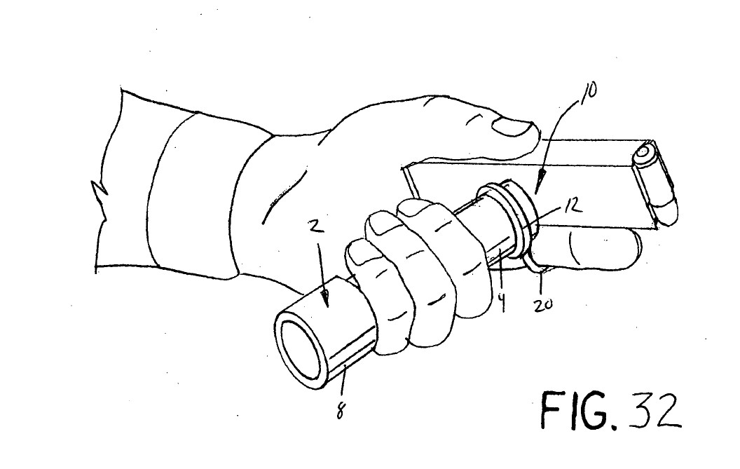

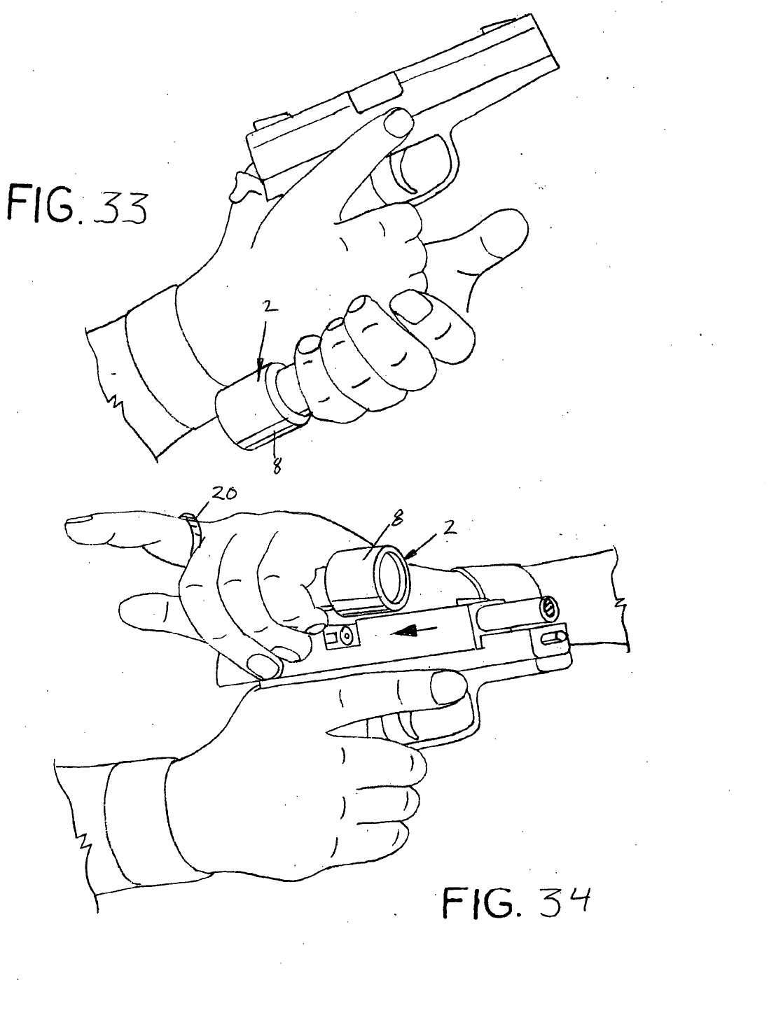

FIGS. 30-34 illustrate the method of using the retention devices of this invention during weapon reloads, malfunctions and clearance/stoppage operations. During a reload, malfunction or clearance/stoppage operation, the shooter opens his hand and loosen his grasp of flashlight 2 between his fingers and flips flashlight 2 around into his palm with his index finger and thumb extended (FIG. 30). Alternatively, the shooter can extend his last three fingers and let flashlight 2 “roll” downward into the palm. With flashlight 2 lying across his palm, but still in retention with his index finger inserted through finger loop 20, the shooter closes his grip with his last three fingers “nesting flashlight 2 in the palm (FIG. 31). In this position, the shooter's index finger and thumb are free to retrieve and index a magazine for a reload (FIG. 32), insert the magazine into the firearm (FIG. 33) and work the firearm slide (FIG. 34). Each of these functions are performed while the shooter maintains positive control of flashlight 2 using retention device 10 in one hand and the firearm in the other hand. In addition, the shooter from this position can activate flashlight 2 by depressing the tail-end switch 6 with his thumb when necessary. The retention device and its method of use allows all traditional reloading, malfunction and clearance/stoppage operations to be performed without deviating from any fundamentals of marksmanship.

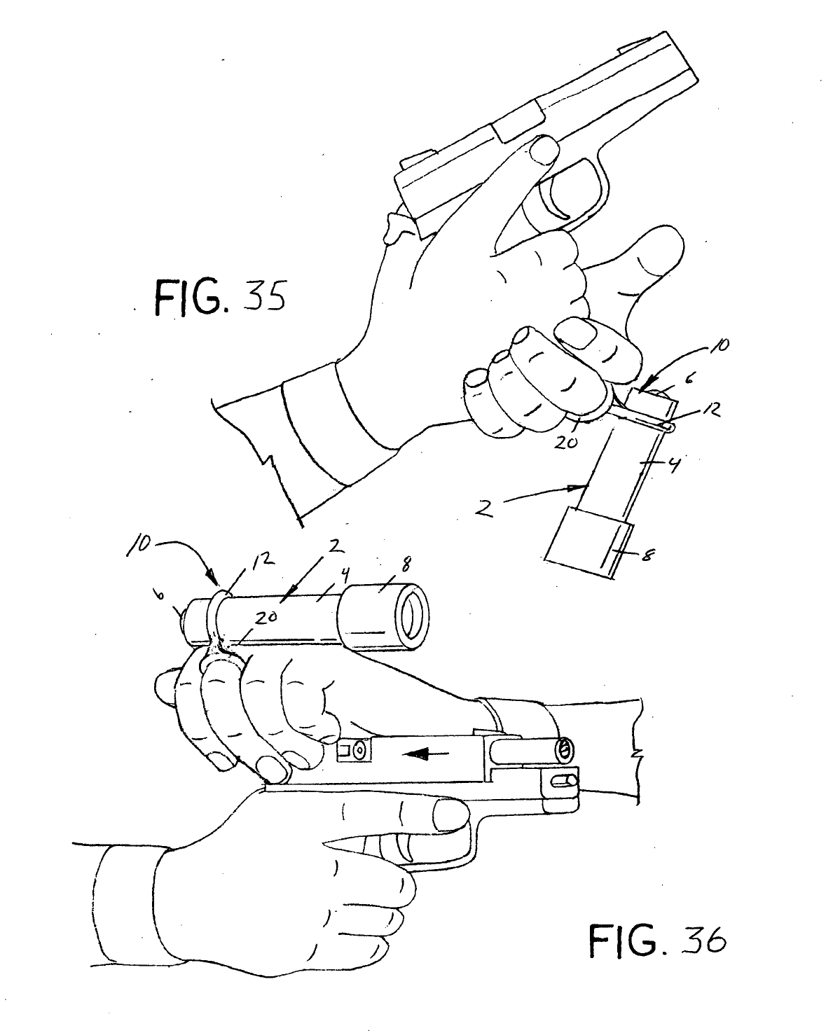

FIGS. 35-36 illustrate an alternative method of use of the retention devices of this invention during weapon reloads, malfunctions and clearance/stoppage operations. In this alternative method, the middle finger of the shooter's non-weapon hand is inserted through finger loop 20 with flashlight 2 positioned between his index and middle fingers. To effect a reload, malfunction or clearance/stoppage operation, the shooter simply loosens his grip on flashlight 2 allowing it to pivot downward and rest across the back of his fingers (FIGS. 35 and 36). Again, flashlight 2 is positively retained by the shooter's middle finger extending through finger loop 20, but all of the shooter's fingers are available to perform other operations. Again, this alternative method of employing the retention device allows all traditional firearm operations to be performed without deviating from any fundamentals of marksmanship.

One skilled in the art will note that retention devices of this invention and their method of use allows any shooter, regardless of their hand size, to effectively employ both a flashlight and firearm, while keeping both hands together, without any significant compromise to the fundamental two handed combat grip. The retention device also allows the shooter to maintain positive retention of the flashlight during all firearm operations from presentation to clearance/stoppage without deviating from any fundamental firearm or marksmanship techniques. The retention device and its method of use can be readily modified to provide direct illumination or indirect ambient illumination. The finger loop and hook allow the shooter to positively retain the flashlight during the execution of all firearm operations from presentation to clearance/stoppage. The retention device can be adapted for use with any hand-held flashlight having a tail-end activation switch. The simplicity of the design and construction of the retention devices make them economical for broad application and use. The simplicity of use makes the retention devices of this invention practical for both tactical and non-tactical use.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A retention device for a hand-held flashlight having a longitudinal body, a lamp assembly fitted to one end of the flashlight body and a longitudinally actuated tail-end activation switch mounted at the other end of the flashlight body, the retention device comprising:
an annular band adapted to fit around the body of the flashlight adjacent the tail-end activation switch, the band extending radially around the flashlight having a chamfered edge against which a shooter's fingers contact the band; and a finger retention part extending from the band.

2. The retention device of claim 1 wherein the retention part is an integral loop adapted to receive a human finger therethrough.

3. The retention device of claim 2 wherein the integral loop perpendicularly extends from the band.

4. The retention device of claim 1 wherein the retention part is an integral hook.

5. The retention device of claim 1 wherein the retention devices is constructed of a material having resilient and elastic properties such that the band may be secured to the flashlight by a friction fit and the retention part may be deformed.

6. A method for simultaneously operating and manipulating a firearm and hand-held flashlight where 1) the firearm includes a grip having a magazine well formed therein, a shiftable slide and a magazine, and 2) the flashlight includes a longitudinal body, a lamp assembly fitted to one end of the flashlight body and a longitudinally actuated tail-end activation switch mounted at the other end of the flashlight body and a retention device, the retention device including an annular band fitted around the body of the flashlight adjacent the tail-end activation switch,
the method comprising the following steps:
a. holding the flashlight body between adjacent fingers of one hand so that the adjacent fingers contact and abut the band and the tail-end activation switch faces the palm of the one hand;
b. holding the firearm with the other hand;
c. marrying the one hand grasping the flashlight with the other hand grasping the firearm so that the one hand overlies the other hand and the lamp assembly extends outward from the one hand and the tail-end activation switch is juxtaposed between the one hand and the fingers of the other hand;
d. applying pressure with the one hand to the band to urge the tail-end activation switch against the fingers of the other hand to activate the flashlight.

7. A method for simultaneously manipulating a firearm and hand-held flashlight to clear a stoppage malfunction where 1) the firearm includes a grip having a magazine well formed therein, a shiftable slide and a magazine, and 2) the flashlight includes a longitudinal body, a lamp assembly fitted to one end of the flashlight body and a longitudinally actuated tail-end activation switch mounted at the other end of the flashlight body and a retention device, the retention device including an annular band fitted around the body of the flashlight adjacent the tail-end activation switch,
the method comprising the following steps:
a. holding the flashlight body between adjacent fingers of one hand so that the fingers abut the edge of the band and the tail-end activation switch is adjacent the palm of the one hand;
b. holding the firearm with the other hand;
c. rolling the flashlight in the one hand so that the flashlight is nested in the palm of the one hand and held by the pinky finger and ring fingers of the one hand;
d. racking the slide using the grasp of the middle finger, index finger and thumb of the one hand against the slide while the one hand is still holding the flashlight to clear a malfunction of the firearm and the other hand supports the firearm.

8. A method for simultaneously operating and manipulating a firearm and hand-held flashlight where 1) the firearm includes a grip having a magazine well formed therein, a shiftable slide and a magazine, and 2) the flashlight includes a longitudinal body, a lamp assembly fitted to one end of the flashlight body and a longitudinally actuated tail-end activation switch mounted at the other end of the flashlight body and a retention device, the retention device including an annular band fitted around the body of the flashlight adjacent the tail-end activation switch and a finger loop extending from the band,
the method comprising the following steps:
a. holding the flashlight body between adjacent fingers of one hand with one finger of the one hand inserted through the finger loop so that the one finger and an adjacent finger contact and abut the band and the tail-end activation switch faces the palm of the one hand;
b. holding the firearm with the other hand;
c. marrying the one hand grasping the flashlight with the other hand grasping the firearm so that the one hand overlies the other hand and the lamp assembly extends outward from the one hand and the tail-end activation switch is juxtaposed between the one hand and the fingers of the other hand;
d. applying pressure with the one hand to the band to urge the tail-end activation switch against the fingers of the other hand to activate the flashlight.

9. A method for simultaneously manipulating a firearm and hand-held flashlight to clear a stoppage malfunction where 1) the firearm includes a grip having a magazine well formed therein, a shiftable slide and a magazine, and 2) the flashlight includes a longitudinal body, a lamp assembly fitted to one end of the flashlight body and a longitudinally actuated tail-end activation switch mounted at the other end of the flashlight body and a retention device, the retention device including an annular band fitted around the body of the flashlight adjacent the tail-end activation switch and a finger loop extending from the band,
the method comprising the following steps:
a. holding the flashlight body between adjacent fingers of one hand with one finger of the one hand inserted through the finger loop so that the one finger and an adjacent finger contact and abut the band and the tail-end activation switch faces the palm of the one hand;
b. holding the firearm with the other hand;
c. rotating the flashlight from between the one finger and the adjacent finger while the flashlight is retained in the one hand by the one finger being inserted through the finger loop;
d. racking the slide using the grasp of the middle finger, index finger and thumb of the one hand against the slide while the one hand is still holding the flashlight to clear a malfunction of the firearm and the other hand supports the firearm.

10. The method of claim 9 wherein step c also includes rotating the flashlight so that the flashlight nests in the palm of the one hand held by the pinky finger and ring finger of the one hand.

11. The method of claim 9 wherein step c also includes rotating the flashlight so that the flashlight overlies the back of the one hand.
